(19) United States
(12) Patent Application Publication
(10) Pub. No.: US 2008/0041215 A1
(43) Pub. Date: Feb. 21, 2008

(54) Drum hoop for tom-tom

(76) Inventor: Wei-Pin Wang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/506,482

(22) Filed: Aug. 21, 2006

(51) Int. Cl. G10D 13/02

(52) U.S. Cl. 84/411 R

(57) ABSTRACT

A drum hoop for a tom-tom includes a wooden outer layer, and a metallic inner layer mounted in the outer layer. Thus, the inner layer of the drum hoop is made of metallic material, so that the drum hoop has a greater strength to withstand a striking action of the stick, thereby enhancing the lifetime of the drum hoop. In addition, the outer layer of the drum hoop is made of wooden material, so that the drum hoop has the natural sound effect, thereby enhancing the sound quality of the drum hoop.

### BACKGROUND OF THE INVENTION

1. Field of the Invention

The present invention relates to a drum hoop and, more particularly, to a drum hoop for a musical instrument, such as a tom-tom and the like.

2. Description of the Related Art

A drum hoop for a musical instrument, such as a tom-tom and the like, is used to secure the batter head to the shell of the tom-tom. The conventional drum hoop usually comprises a die cast hoop made of wooden material and a counterhoop made of metallic material.

The drum hoop made of wooden material maintains the natural sound effect, thereby enhancing the sound quality of the drum hoop. However, the strength of the drum hoop made of wooden material is not large enough to withstand a striking action of the stick during a long-term utilization, thereby decreasing the lifetime of the drum hoop. In addition, the sound effect of the drum hoop made of wooden material is easily affected by variation of the climate condition, such as the moisture or temperature, thereby decreasing the sound quality of the drum hoop.

The drum hoop made of metallic material has a greater strength to withstand a striking action of the stick, thereby enhancing the lifetime of the drum hoop. In addition, the sound effect of the drum hoop made of metallic material is not affected by variation of the climate condition, such as the moisture or temperature, thereby maintaining the sound quality of the drum hoop. However, the drum hoop made of metallic material does not have the natural sound effect, thereby decreasing the sound quality of the drum hoop.

### BRIEF SUMMARY OF THE INVENTION

In accordance with the present invention, there is provided a drum hoop, comprising a wooden outer layer, and a metallic inner layer mounted in the outer layer.

The primary objective of the present invention is to provide a drum hoop, wherein the inner layer of the drum hoop is made of metallic material, so that the drum hoop has a greater strength to withstand a striking action of the stick, thereby enhancing the lifetime of the drum hoop.

Another objective of the present invention is to provide a drum hoop, wherein the inner layer of the drum hoop is made of metallic material, so that the drum hoop has a solid and stable construction to tolerate variation of the moisture and temperature to prevent the sound effect of the drum hoop from being affected or decreased due to variation of the climate condition, thereby maintaining the sound quality of the drum hoop.

A further objective of the present invention is to provide a drum hoop, wherein the outer layer of the drum hoop is made of wooden material, so that the drum hoop has the natural sound effect, thereby enhancing the sound quality of the drum hoop.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a drum hoop for a tom-tom in accordance with the preferred embodiment of the present invention.

FIG. 2 is a top plan view of the drum hoop as shown in FIG. 1.

FIG. 3 is a locally plan cross-sectional enlarged view of the drum hoop as shown in FIG. 2.

### DETAILED DESCRIPTION OF THE INVENTION

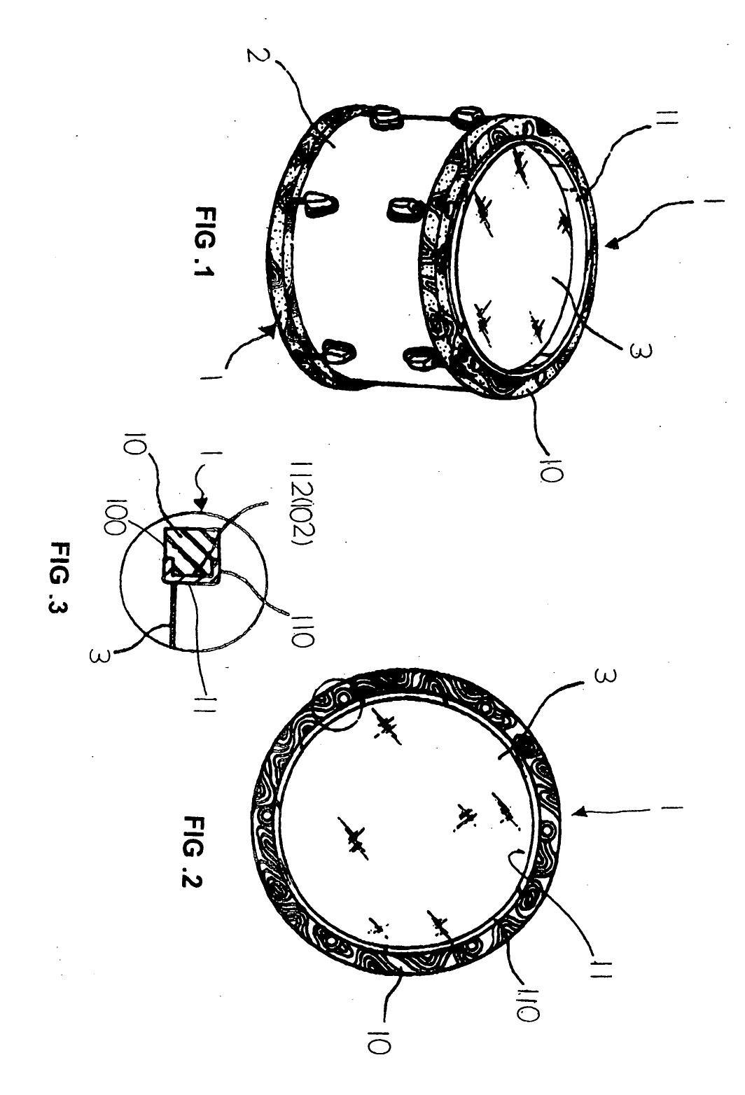

Referring to the drawings and initially to FIG. 1, a tom-tom in accordance with the preferred embodiment of the present invention comprises a shell 2, two drum hoops 1 mounted on top and bottom sides of the shell 2, and two batter heads 3 each mounted in the respective drum hoop 1.

Referring to FIGS. 1-3, each of the drum hoops 1 in accordance with the preferred embodiment of the present invention comprises a wooden outer layer 10, and a metallic inner layer 11 mounted in the outer layer 10 and connected to the respective batter head 3.

The inner layer 11 is enclosed around an inner rim of the outer layer 10. The inner layer 11 has a substantially U-shaped cross-sectional profile as shown in FIG. 3, and has two flanges 110 rested on top and bottom sides of the inner rim of the outer layer 10. Each of the flanges 110 of the inner layer 11 has an annular tapered shape and is extended radially and outwardly toward the outer layer 10. The inner layer 11 has an outer side formed with a receiving groove 112 located between the flanges 110 and an inner side connected to the respective batter head 3.

The inner rim of the outer layer 10 is formed with a reduced insertion block 102 inserted into the receiving groove 112 of the inner layer 11 and clamped between the flanges 110 of the inner layer 11 so that the inner rim of the outer layer 10 is encompassed by the outer side of the inner layer 11 closely and completely. The insertion block 102 of the outer layer 10 has an annular stepped shape and has top and bottom sides each formed with a recessed shoulder 100 rested on the respective flange 110 of the inner layer 11.

Accordingly, the inner layer 11 of the drum hoop 1 is made of metallic material, so that the drum hoop 1 has a greater strength to withstand a striking action of the stick, thereby enhancing the lifetime of the drum hoop 1. In addition, the inner layer 11 of the drum hoop 1 is made of metallic material, so that the drum hoop 1 has a solid and stable construction to tolerate variation of the moisture and temperature to prevent the sound effect of the drum hoop 1 from being affected or decreased due to variation of the climate condition, thereby maintaining the sound quality of the drum hoop 1. Further, the outer layer 10 of the drum hoop 1 is made of wooden material, so that the drum hoop 1 has the natural sound effect, thereby enhancing the sound quality of the drum hoop 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A drum hoop, comprising:
a wooden outer layer;
a metallic inner layer mounted in the outer layer.

2. The drum hoop in accordance with claim 1, wherein the inner layer is enclosed around an inner rim of the outer layer.

3. The drum hoop in accordance with claim 2, wherein the inner layer has two flanges rested on top and bottom sides of the inner rim of the outer layer.

4. The drum hoop in accordance with claim 3, wherein each of the flanges of the inner layer has an annular tapered shape.

5. The drum hoop in accordance with claim 3, wherein each of the flanges of the inner layer is extended radially and outwardly toward the outer layer.

6. The drum hoop in accordance with claim 1, wherein the inner layer has an outer side formed with a receiving groove located between the flanges.

7. The drum hoop in accordance with claim 6, wherein the inner rim of the outer layer is formed with a reduced insertion block inserted into the receiving groove of the inner layer and clamped between the flanges of the inner layer so that the inner rim of the outer layer is encompassed by the outer side of the inner layer closely and completely.

8. The drum hoop in accordance with claim 7, wherein the insertion block of the outer layer has top and bottom sides each formed with a recessed shoulder rested on the respective flange of the inner layer.

9. The drum hoop in accordance with claim 7, wherein the insertion block of the outer layer has an annular stepped shape.

10. The drum hoop in accordance with claim 1, wherein the inner layer is connected to a batter head.

11. The drum hoop in accordance with claim 10, wherein the inner layer has an inner side connected to the batter head.

12. The drum hoop in accordance with claim 3, wherein the inner layer has a substantially U-shaped cross-sectional profile.
